(19) United States
(12) Patent Application Publication
(10) Pub. No.: US 2010/0311021 A1
(43) Pub. Date: Dec. 9, 2010

(54) METHOD OF EDUCATION AND EDUCATIONAL AIDS

(76) Inventor: Diane Joan Abello, New South Wales (AU)

Correspondence Address: MAIER & MAIER, PLLC, 1000 DUKE STREET, ALEXANDRIA, VA, 22314, US

(21) Appl. No.: 12/679,175

(22) PCT Filed: Oct. 3, 2007
(86) PCT No.: PCT/AU2007/001462

§ 371 Date: Mar. 19, 2010

(51) Int. Cl. G09B 5/00; G09B 17/00

(52) U.S. Cl. 434/169; 434/178; 434/317

(57) ABSTRACT

A method of educating a learner, comprising the steps of displaying a first level text (15) to the learner and then displaying a second level text (25) to the learner comprising the same words as the first level text (15) and wherein two or more words of the second level text (25) are concatenated to form at least one word group to prompt the learner to read the concatenated words in quick succession improving the learner's reading fluency.

### FIELD OF THE INVENTION

The present invention relates to education and in particular relates to reading and improving reading fluency.

The invention has been developed primarily for both a paper/book/booklet form and for a computerized form for use in schooling and will be described hereinafter with reference to this application. However, it will be appreciated that the invention could also be used in other educational contexts (e.g. in a workplace).

### BACKGROUND OF THE INVENTION

People learn to read fluently through regular reading of text, listening to people speak, proper modeling at home or at an educational institution and by being told how to read (e.g. being told to read with expression). Unfortunately, some readers are not involved in such learning situations and although they may learn to read at a basic level, they do not learn to read fluently. This makes it more difficult for them to comprehend the text.

One example of a known reading program is called the “Reading Recovery Program”. The Reading Recovery Program incorporates a number of different learning techniques. One aspect of the Reading Recovery Program involves the reader placing their fingers at either end of a phrase or chunk of words in a sentence. This encourages reading with fluency. The students in the infant grade are on the program for a set time with constant monitoring of results.

Some educational programs teach reading and comprise a number of texts of increasing levels of difficulty for a learner to read.

Such programs are not highly effective in teaching oral reading fluency. No matter how often fluency is modeled, some readers have difficulty applying or reproducing the modeling. Some readers do not understand the fluency pattern of reading. Sometimes a reader can begin reading a text fluently but is unable to keep reading the text fluently.

The present invention seeks to provide a method of education and educational aids which will overcome or substantially ameliorate this problem, or to at least provide an alternative.

### SUMMARY OF THE INVENTION

According to a first aspect of the invention there is provided a method of educating a learner, comprising the following steps:
Displaying a first level text to the learner, and
Displaying a second level text to the learner comprising the same words as the first level text and wherein two or more words are concatenated to form at least one second level word group to prompt the learner to read the concatenated words in quick succession improving the learner's reading fluency.

Advantageously, the learner's reading fluency is improved. This reduces the time it takes the learner to read a text and consequently, understanding of the text becomes easier and the learner's confidence in enhanced.

Preferably, the method further comprises the following step:
Displaying a third level text to the learner after the step of displaying a second level text to the learner, the third level text comprising the same words as the first level text and wherein two or more words are concatenated to form at least one third level word group, the or at least one of which comprises a greater number of concatenated words than the or each at least one second level word group to prompt the learner to read the concatenated words in quick succession further improving the learner's reading fluency.

Preferably, the method further comprises the following step:
Displaying a fourth level text to the learner after the step of displaying a third level text to the learner, the fourth level text comprising the same words as the first level text and wherein two or more words are concatenated to form at least one fourth level word group, the or at least one of which comprises a greater number of concatenated words than the or each at least one third level word group to prompt the learner to read the concatenated words in quick succession further improving the learner's reading fluency.

Preferably, the method further comprises the following step:
Displaying a fifth level text to the learner after the step of displaying a fourth level text to the learner, the fifth level text comprising the same words as the first level text and wherein two or more words are concatenated to form at least one fifth level word group, the or at least one of which comprises a greater number of concatenated words than the or each at least one fourth level word group to prompt the learner to read the concatenated words in quick succession further improving the learner's reading fluency.

Preferably, the method further comprises the following step:
Repeating the previous steps wherein the respective texts are mildly more linguistically complex but relate to substantially corresponding subject matter.

Preferably, the method further comprises the following step:
Repeating the steps of any one of the above paragraphs, wherein the respective texts are moderately more linguistically complex but relate to substantially corresponding subject matter.

Preferably, the method further comprises the following step:
Repeating the steps of any one of the above paragraphs, wherein the respective texts are significantly more linguistically complex but relate to substantially corresponding subject matter.

Preferably, the method further comprises the following steps:
Timing the time taken by the learner to read the first level text before the step of displaying the second level text and recording the time taken as an initial time.
Timing the time taken by the learner to read the first level text after the step of displaying the highest level text to the learner and the learner having read the highest level text at least once and recording the time taken as a final time.

Preferably, the highest level text is read by the learner twice before the final time is recorded.

Preferably, the method further comprises the following step:
Comparing the final time to the initial time to observe whether the learner is reading more fluently.

Preferably, the method further comprises the following steps if a word is not known by the learner:
Communicating the pronunciation of the word audibly, then
Prompting the learner to repeat the word.

Preferably, at least one of the words in the or each word group is displayed in a different colour to another word in the or each respective word group.

Preferably, colours of adjacent words in the or each respective word group alternate.

Preferably, colours of adjacent words in the second level text and in higher level texts, if applicable, alternate.

Preferably, the method further comprises the step of allowing a learner to select the of the at least one of the words from a group of at least two colours according to personal preference.

Preferably, the color group comprises the colours orange and blue.

Preferably, the method further comprises the step of allowing a learner to select a different colour from the colour group.

Preferably, the at least one of the words displayed in a different is also displayed in bold and/or italicized.

Preferably, the or each word group is spaced from adjacent words by more than one stroke of a computer space bar.

Preferably, only one text is displayed to the learner at a time.

Preferably, the texts form a story.

Preferably, the method further comprises the following step:
Repeating the preceding steps wherein the texts form a different story.

According to a second aspect of the invention an educational aid is provided comprising a book displaying the texts of any one of the preceding claims.

Preferably, the book comprises a multiplicity of pages and each text is displayed on a separate page.

Preferably, at least one of the pages comprises a recording portion in which the initial time and final time may be recorded.

Preferably, the educational aid further comprises a tracking aid comprising a thin plate having a rectangular window therein such that in use a user can move the tracking aid down a text as they read it and only view between one and three complete lines of the text at a time.

Preferably, one side of the thin plate is coloured in a first colour and the other side of the thin plate is coloured in a second colour such that a learner may select which colour faces towards them in use.

According to a third aspect of the invention there is provided computer executable process steps stored on a computer readable medium, operative to control a computer to perform the steps of any one of the preceding paragraphs.

According to a fourth aspect of the invention there is provided a computer program adapted to execute the steps of any one of the preceding paragraphs when run on a computer.

According to a fifth aspect of the invention there is provided a computer comprising:
a processor,
a display operatively connected to the processor,
a memory device operatively connected to the processor and containing the above computer program for execution by the processor, and wherein the display is adapted to display the respective texts to the learner.

Preferably, the computer program is recorded on a data storage means.

According to a sixth aspect of the invention there is provided a data storage means comprising the above computer program and being adapted for operative connection to a computer for execution of the computer program.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 is a flowchart illustrating a method of educating a learner in accordance with a preferred embodiment of the present invention;

FIG. 2 illustrates a display of the method of FIG. 1 comprising a first level, linguistically non-complex text;

FIG. 3 illustrates a display of the method of FIG. 1 comprising a second level, linguistically non-complex text;

FIG. 4 illustrates a display of the method of FIG. 1 comprising a third level, linguistically non-complex text;

FIG. 5 illustrates a display of the method of FIG. 1 comprising a fourth level, linguistically non-complex text;

FIG. 6 illustrates a display of a method of educating a learner in accordance with another preferred embodiment of the present invention comprising a first level, linguistically mildly complex text;

FIG. 7 illustrates a display of the method of FIG. 6 comprising a second level, linguistically mildly complex text;

FIG. 8 illustrates a display of the method of FIG. 6 comprising a third level, linguistically mildly complex text;

FIG. 9 illustrates a display of the method of FIG. 6 comprising a fourth level, linguistically mildly complex text;

FIG. 10 illustrates a display of the method of FIG. 6 comprising a first level, linguistically moderately complex text;

FIG. 11 illustrates a display of the method of FIG. 6 comprising a second level, linguistically moderately complex text;

FIG. 12 illustrates a display of the method of FIG. 6 comprising a third level, linguistically moderately complex text;

FIG. 13 illustrates a display of the method of FIG. 6 comprising a fourth level, linguistically moderately complex text;

FIG. 14 illustrates a display of the method of FIG. 6 comprising a first level, linguistically significantly complex text;

FIG. 15 illustrates a display of the method of FIG. 6 comprising a second level, linguistically significantly complex text;

FIG. 16 illustrates a display of the method of FIG. 6 comprising a third level, linguistically significantly complex text;

FIG. 17 illustrates a display of the method of FIG. 6 comprising a fourth level, linguistically significantly complex text;

FIG. 18 illustrates a record display of an educational aid in accordance with another embodiment of the invention;

FIG. 19 illustrates a vocabulary display of an educational aid in accordance with another embodiment of the invention;

FIG. 20 illustrates a tracking aid of an educational aid in accordance with another embodiment of the invention; and

FIG. 21 illustrates a computer in accordance with another embodiment of the invention.

### DETAILED DESCRIPTION OF SPECIFIC EMBODIMENTS

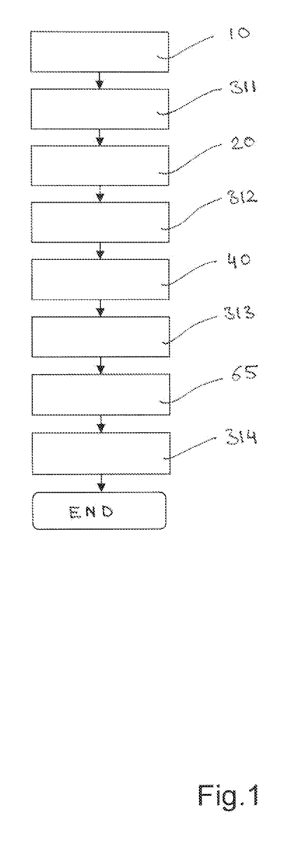

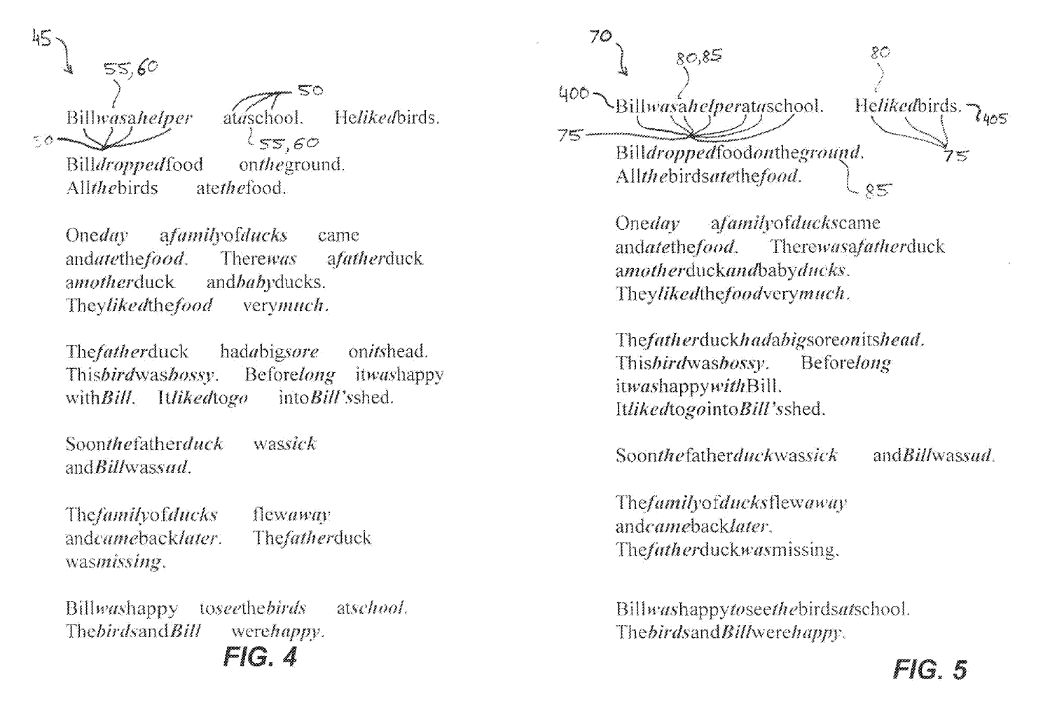

Referring to FIGS. 1 to 5, a method of educating a learner is provided and has been particularly developed to aid readers experiencing difficulty with fluency.

In one embodiment, the method comprises the following steps:

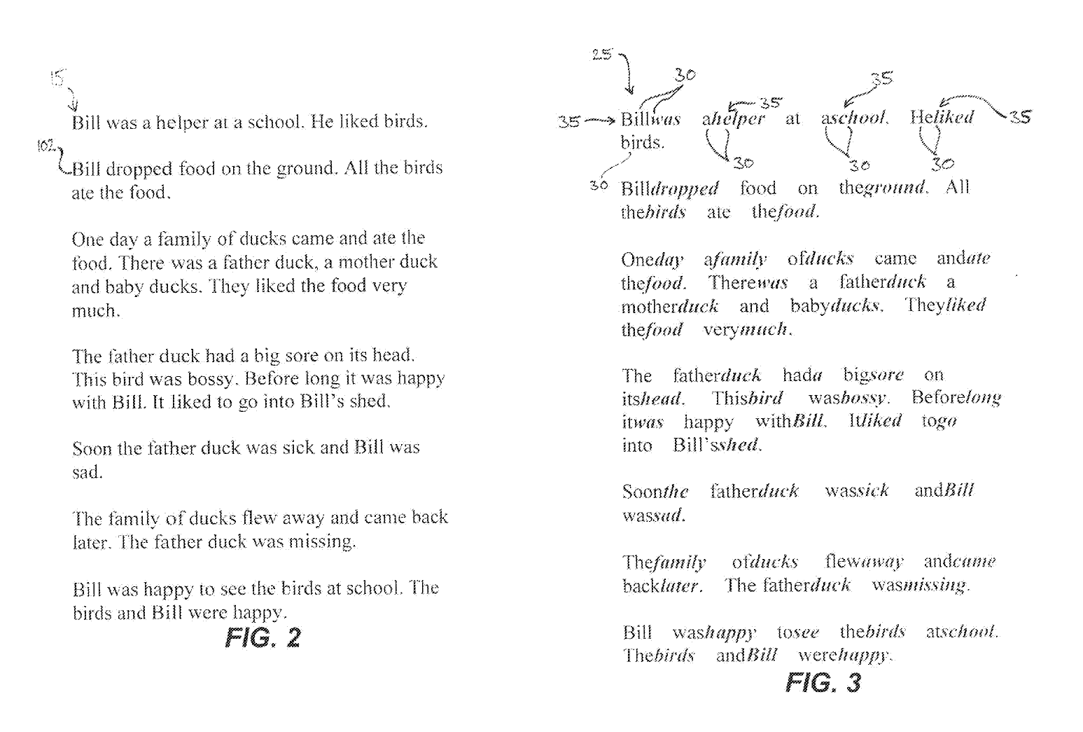

A first step 10 involves displaying a first level text 15 to the learner. In this case, the text 15 is a simple story entitled, “The Birds” which is one page in length and is depicted in FIG. 2. The language of the text 15 is relatively simple and will be denoted a “Stage 1” text. The first level text 15 is all in regular font and one space bar gap is provided between each of the words.

A second step 20 involves displaying a second level text 25 to the learner. The second level text 25 comprises the same words as the first level text 15 (i.e. it is the same story) and thus is also a Stage 1 text. However, a number of words 30 have been concatenated to form a number of second level word groups 35. As the learner reads through the second level text 25 the omission of spaces between the concatenated words 30 of the word groups 35 prompts the learner to read the concatenated words 30 in quick succession. This improves the learner's reading fluency since the learner is not pausing for too long between words they may have otherwise paused between.

Advantageously, this method improves the learner's reading fluency. This reduces the time it takes the learner to read a text and consequently, understanding of the text becomes easier and the learner's confidence in enhanced.

In the depicted embodiment the concatenation of the words 30 is carried out according to a first grammatical & format rule set. The first grammatical and format rule set is as follows:
The subject may be one word, so it is joined to the a simple verb, without a gap.
The subject may remain separate when the verb has an auxiliary verb which is then joined to the participle.
The subject may consist of an article or a possessive pronoun and a noun (that is, the subject), so the two words are joined together, without a gap.
The second word of the two second level word groups 35 is differentiated from the preceding word by a change to italics and colour.
If there is an adjective in the subject of the principal clause (the main sentence), generally the adjective and the noun (subject) are joined without a gap and the article or the possessive pronoun remains separate.
If the sentence begins with an adverb, participle or short phrase, the adverb, participle or short phrase generally remains separate from the rest of the sentence. For example, in the phrase “soonthe fatherduck wassick andBill wassad”, the word “soon” may be separated from the rest of the words in the phrase by a space.
If there are four words in the subject of the sentence, generally the first and the succeeding word are joined and the last and the preceding word are joined and there is a gap between the two second level word groups 35.
If the subject of the sentence has more than four words in it, there are two or more second level word groups 35 with a gap between the two or more second level word groups 35 and any extra words are placed at the beginning or between the second level word groups 35.
The joining of words is dependent on the rhythm of the text.
A predicate has a verb, usually an object, maybe an adverb, and maybe one or more phrases and/or clauses.
The verb generally remains separate from the subject where the subject has more than one word.
The verb is joined to the subject of the sentence where the subject is only one word. The words are joined without a gap.
Generally the adverb joins the verb where the subject of the sentence has more than one word. The words are joined without a gap.
Generally the adverb remains separate when the verb joins the subject.
Where the object of a sentence has an article and there isn't an adjective, the two words are joined without a gap.
Where the object has an adjective, the two words are joined without a gap and if there is an article or possessive pronoun it remains separate.
Where there is a phrase of three words, the noun and the preceding word are joined without a gap and the third word, the preposition, remains separate.
If there are four words in the phrase, generally the first and the succeeding word are joined without a gap and the third and the succeeding word are joined without a gap. There is a gap between the second level word groups 35.
If there are five words in a long phrase, generally, the last and the preceding word is joined without a gap, the next two preceding words are joined without a gap and the fifth word, the preposition, remains separate.
If there are six words in a phrase, generally, there are three second level word groups 35, without a gap within the sets but a space between the sets of words.
If there are more than six words in a phrase, generally, the last and the preceding word are joined without a gap, the next two preceding words are joined without a gap, and the same process is continued, working backwards from the end of the phrase and in an odd number of words in a phrase, the first word remains separate. There is a gap between the second level word groups 35.
The sentence may have a subordinate clause in addition to the principal clause.
Where there is a subordinate clause, the conjunction maybe joined to the succeeding word, a noun, pronoun, adjective, adverb or verb, without a gap.
In the subordinate clause, if an adverb is adjacent to a verb, generally the verb and adverb are joined without a gap and the conjunction remains separate. There is a gap between the sets of words.
In the subordinate clause, generally the article or the possessive pronoun is joined to a noun without a gap. There is a gap between the second level word groups 35.
In the subordinate clause, the article or possessive pronoun maybe joined to an adjective where there are succeeding words in the clause.
In the same clause, if the article or possessive pronoun is joined to the adjective, without a gap, and there is a second adjective and succeeding word, the adjective and succeeding word may be joined, without a gap.
The last word in the clause is joined to the preceding word without a gap and the second level word groups 35 are separated by a gap.
Infinite verbs are joined.
The combination of words may vary depending on the flow of the text.

In this embodiment, the learner reads aloud the second level text 25, at least twice, pausing only at the spaces.

The learner reads a number of second level word groups 35 in their entirety without pausing and then pauses at the gap.

A listener judges the number of times the learner should read the second level text 25.

It should be appreciated that in other embodiments the concatenation of words 30 need not be carried out according to a grammatical and format rule set.

A third step 40 involves displaying a third level text 45 to the learner. The third level text 45 comprises the same words as the first level text 15 (i.e. it is the same story) and thus is also a Stage 1 text. However, a number of words 50 have been concatenated to form a number of third level word groups 55.

Furthermore, a subset of the third level word groups 60 comprise a greater number of concatenated words 50 than any one of the second level word groups 35. For example, the word group “Billwasahelper” comprises four words and the word group “ataschool” comprises three words. Both of these exemplary word groups 60 comprise more words than the second level word groups 35 which, in this case, comprise a maximum of two words. Not all of the third level word groups 60 comprise a greater number of concatenated words 50 than the second level word groups 35.

As the learner reads through the third level text 45 the omission of spaces between the concatenated words 50 of the word groups 55 prompts the learner to read the concatenated words 50 in quick succession. This improves the learner's reading fluency since the learner is not pausing for too long between words they may have otherwise paused between.

In the depicted embodiment the concatenation of the words 50 is carried out according to a second grammatical & format rule set. The second grammatical and format rule set is as follows:
Three to four words are joined without a gap between the words.
Where there are two second level word groups 35 in the second level text 25, in the subject or predicate or clause/s, another word is joined to make three words together without a gap.
Where there are two consecutive sets of two second level word groups 35 in the second level text 25, the two sets are joined to make four third level word groups 55 without a gap, in the third level text 45.
In the joined group of words, a word is differentiated by a change to italics and the preceding and succeeding words around them are of a regular font as is printed in the first level text 15.
In the joined group of words, words that are differentiated not only by a change to italics, also by a change of colour, as in the second level text 25.
The learner reads a number of third level word groups 55 in its entirety without pausing and then pauses at the gap.
The learner reads the third level text 45 at least twice, pausing at the spaces (gaps).
Any relevant information is then recorded.

It should be appreciated that in other embodiments the concatenation of words 50 need not be carried out according to a grammatical and format rule set.

A fourth step 65 involves displaying a fourth level text 70 to the learner. The fourth level text 70 comprises the same words as the first level text 15 (i.e. it is the same story) and thus is also a Stage 1 text. However, a number of words 75 have been concatenated to form a number of fourth level word groups 80.

Furthermore, a subset of the fourth level word groups 85 comprise a greater number of concatenated words 75 than any one of the third level word groups 55. For example, the word group “Billwasahelperataschool” comprises seven words and the word group “Billdroppedfoodontheground” comprises six words. Both of these exemplary word groups 85 comprise more words than the third level word groups 55 which, in this case, comprise a maximum of four words. Not all of the fourth level word groups 80 comprise a greater number of concatenated words 75 than the third level word groups 55.

As the learner reads through the fourth level text 70 the omission of spaces between the concatenated words 75 of the word groups 80 prompts the learner to read the concatenated words 75 in quick succession. This improves the learner's reading fluency since the learner is not pausing for too long between words they may have otherwise paused between.

A further advantage of providing distinct levels is that the total text is divided up into manageable chunks.

In the depicted embodiment the concatenation of the words 75 is carried out according to a third grammatical & format rule set. The third grammatical and format rule set is as follows:
Third level word groups 55 of the third level text 45, are generally combined to make principal clauses, sub-ordinate, adjectival and adverbial, clauses without any gaps between the words in the clauses, a space occurring for an adverb or phrase at the beginning of a sentence to form the fourth level text 70.
The clauses are generally separated by gaps bigger than one space bar gap.
The space between the sets of words is lengthened, that is, more than one space bar gap or the set of joined words is on a new line.
In the fourth level word groups 80, a word is differentiated by a change to italics and the preceding and succeeding words around them are of a regular font, as is written in the first level text 15.
In the fourth level word groups 80, colour is used to differentiate the preceding and succeeding words.

It should be appreciated that in other embodiments the concatenation of the words 75 need not be carried out according to a grammatical and format rule set.

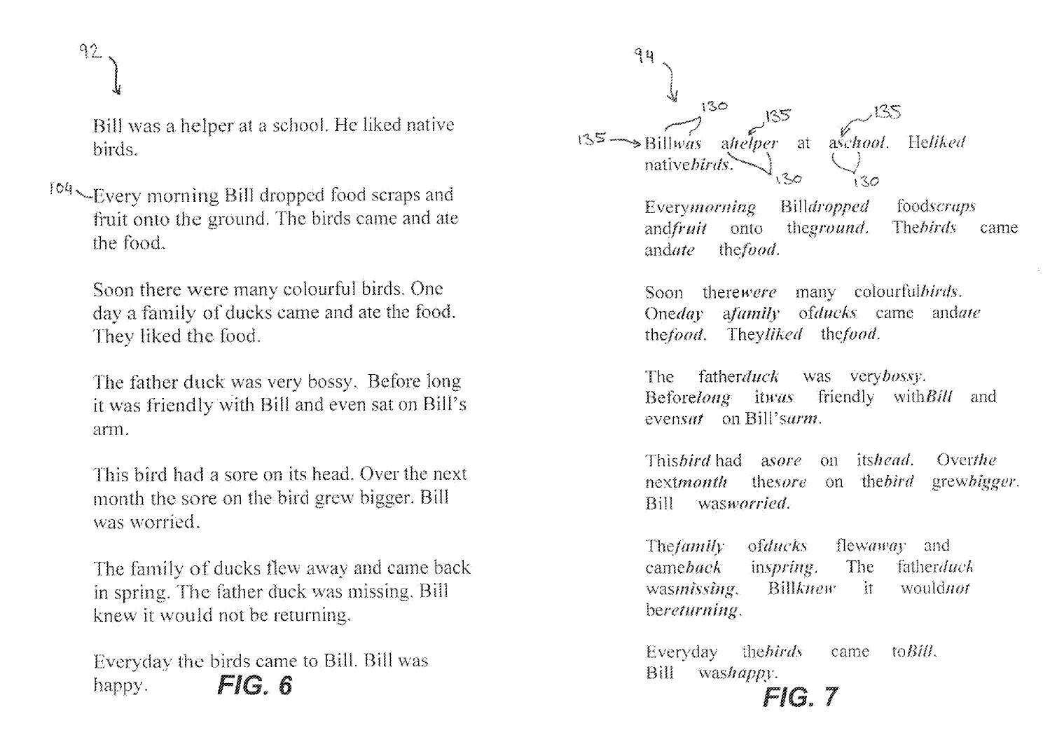

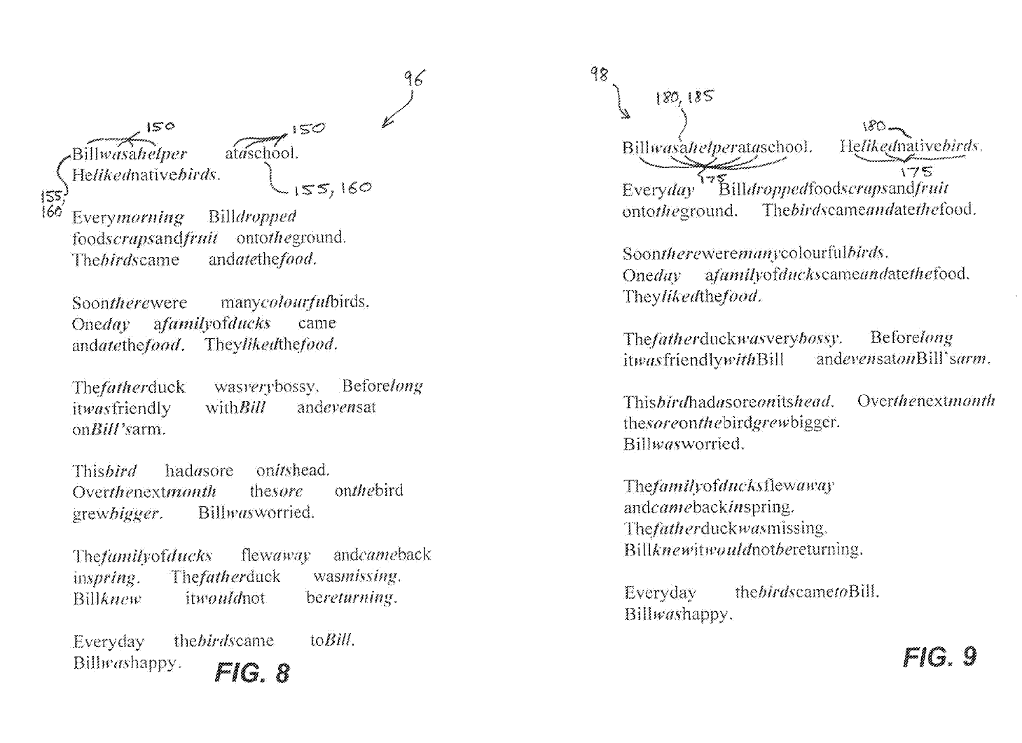

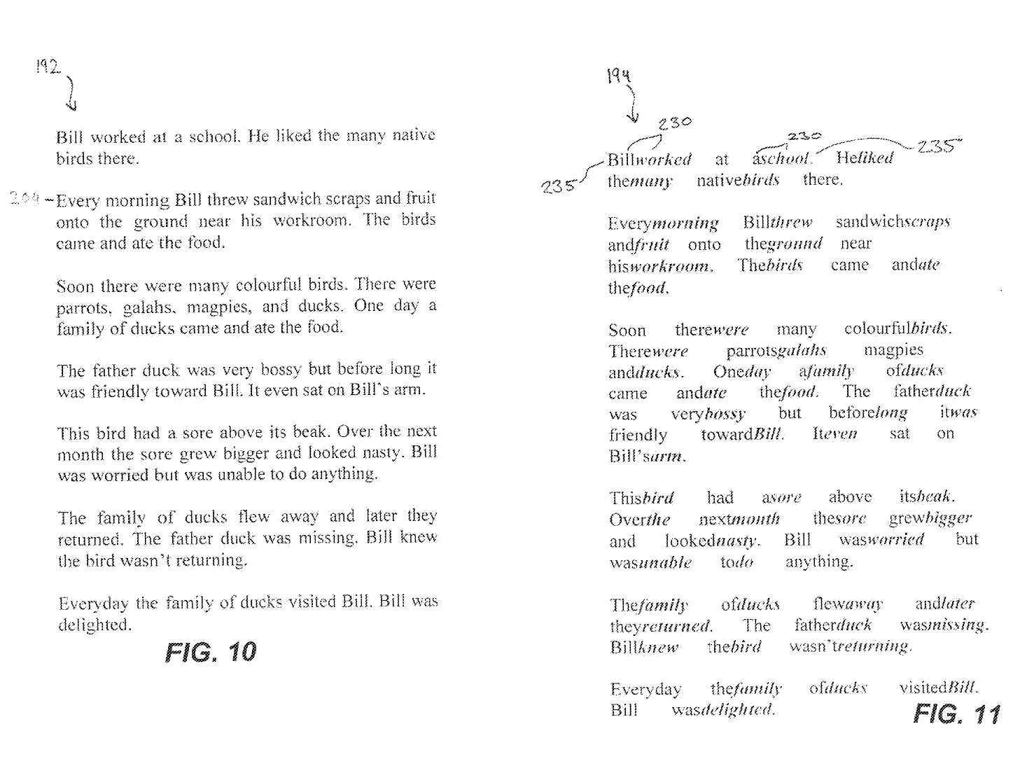

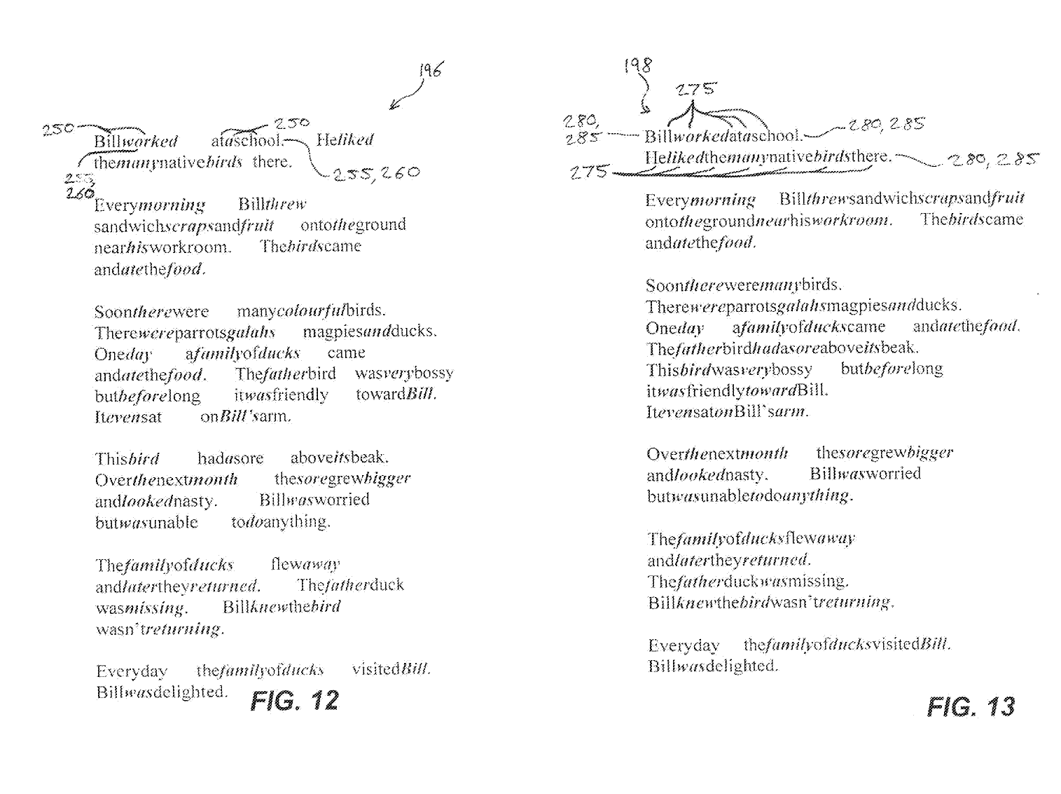

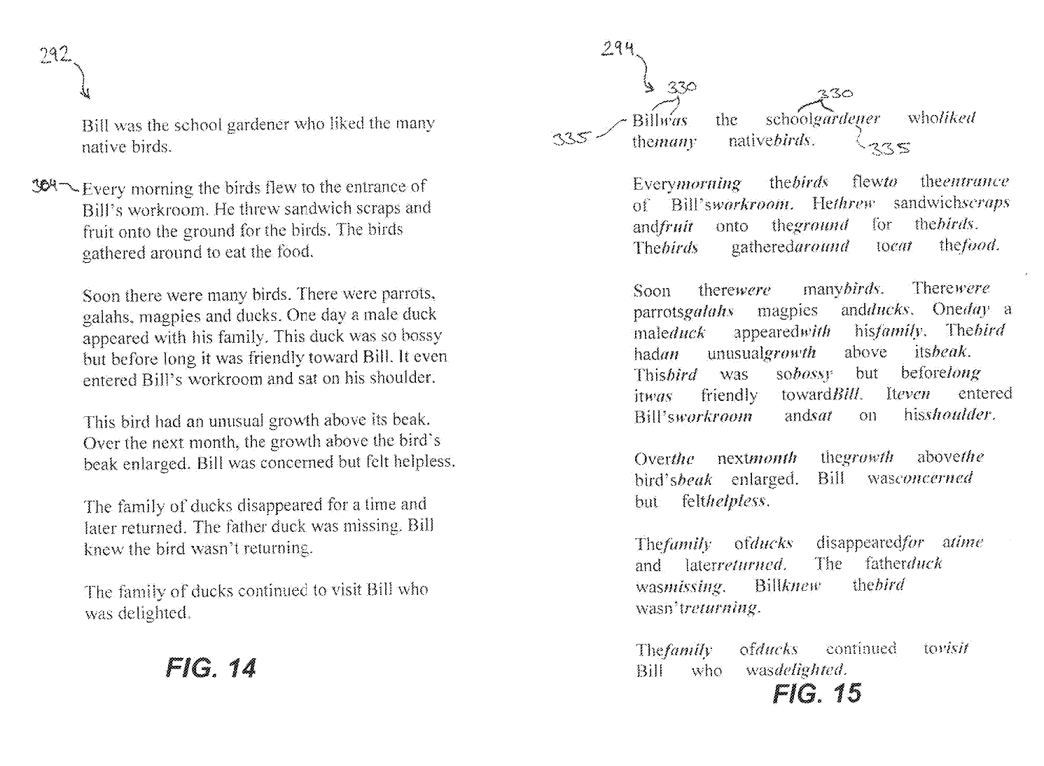

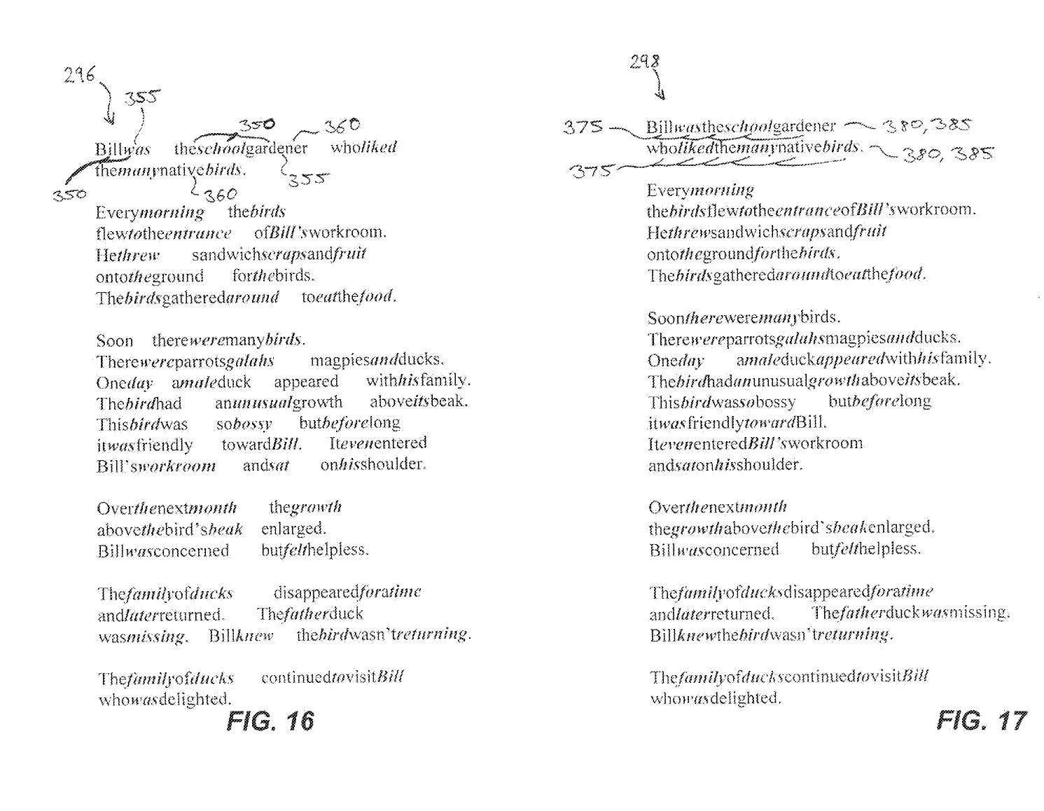

Turning now to FIGS. 6 to 17, a fifth step 90 involves repeating steps 1 to 4 but with what are denoted “Early Stage 2” texts. The Early Stage 2 texts are mildly more linguistically complex than the Stage 1 texts and include a first level Early Stage 2 text 92, a second level Early Stage 2 text 94, a third level Early Stage 2 text 96 and a fourth level Early Stage 2 text 98.

The Early Stage 2 texts relate to subject matter substantially corresponding to the subject matter of the Stage 1 texts. In this case, this means that the Early Stage 2 texts tell a similar story to the Stage 1 texts but with relatively minor linguistic variations. For example, the first level Stage 1 text 15 includes the sentence 102, “Bill dropped food on the ground.” The corresponding sentence 104 of the first level Early Stage 2 text 94 states, “Every morning Bill dropped food scraps and fruit on the ground.”

Other early Stage 2 elements that correspond to Stage 1 elements are denoted by an equivalent reference number to the Stage 1 elements plus one hundred. For example, the first step of Early Stage 2 is first step 110 and so on.

A sixth step 190 involves repeating steps 1 to 4 but with what are denoted “Stage 2” texts. The Stage 2 texts are moderately more linguistically complex than the Stage 1 texts and include a first level Stage 2 text 192, a second level Stage 2 text 194, a third level Stage 2 text 196 and a fourth level Stage 2 text 198.

The Stage 2 texts relate to subject matter substantially corresponding to the subject matter of the Stage 1 texts. In this case, this means that the Stage 2 texts tell a similar story to the Stage 1 texts but with some linguistic variations. For example, the first level Stage 1 text 15 includes the sentence 102, “Bill dropped food on the ground.” The corresponding sentence 204 of the first level Stage 2 text 192 states, “Every morning Bill threw sandwich scraps and fruit onto the ground near his workroom.”

Other Stage 2 elements that correspond to Early Stage 2 elements are denoted by an equivalent reference number to the Early Stage 2 elements plus one hundred. For example, the first step of Stage 2 is first step 210 and so on.

A seventh step 290 involves repeating steps 1 to 4 but with what are denoted “Stage 3” texts. The Stage 3 texts are significantly more linguistically complex than the Stage 1 texts and include a first level Stage 3 text 292, a second level Stage 3 text 294, a third level Stage 3 text 296 and a fourth level Stage 3 text 298. Thus, the Stage 3 texts are the hardest for the learner to read out loud.

The Stage 3 texts relate to subject matter substantially corresponding to the subject matter of the Stage 1 texts. In this case, this means that the Stage 3 texts tell a similar story to the Stage 1 texts but with some significant linguistic variations. For example, the first level Stage 1 text 15 includes the sentence 102, “Bill dropped food on the ground.” The corresponding sentences 304 of the first level Stage 3 text 292 state, “Every morning the birds flew to the entrance of Bill's workroom. He threw sandwich scraps and fruit onto the ground for the birds.”

Other Stage 3 elements that correspond to Stage 1 elements are denoted by an equivalent reference number to the Stage 1 elements plus three hundred. For example, the first step of Stage 3 is first step 310 and so on.

It should be appreciated that the four stages correspond to ascending reading ability and so can be used as a learner progresses in their oral reading fluency. Alternatively, if a learner is already sufficiently progressed in their reading ability they may skip Stage 1 and start at Early Stage 2, Stage 2 or even Stage 3.

In one embodiment, the following timing steps are also utilized.

A first timing step 311 is interposed between Steps 1 and 2 and involves timing the time taken by the learner to read the first level text 15, 92, 192, 292 corresponding to the relevant Stage before the step of displaying the respective second level text 25, 94, 194, 294 and then recording the time taken as an initial time.

A second timing step 312 is analogous to the first timing step 311 except that it is interposed between Steps 2 and 3 and the time taken is recorded as a second time. In this embodiment, the reader must read the respective second level text at least twice.

A third timing step 313 is analogous to the first timing step 311 except that it is interposed between Steps 3 and 4 and the time taken is recorded as a third time. In this embodiment, the reader must read the respective third level text at least twice.

A fourth timing step 314 is analogous to the first timing step 311 except that it is interposed between Steps 4 and 5 and the time taken is recorded as a fourth time. In this embodiment, the reader must read the respective fourth level text at least twice.

A fifth timing step 316 is then provided where the learner reads the first level text 15, 92, 192, 292 corresponding to the relevant Stage again and the time taken is recorded as a final time.

In a sixth timing step 317 the initial and final times are then compared to observe whether the learner is reading more fluently. The second, third and fourth times may also be observed for assessment purposes. In one variation on the second, third and fourth timing steps 312, 313, 314 the respective texts are read only once or more than twice by the learner before moving on to the next step.

In one embodiment, further steps are provided of recording the Name, Date, Story, Stage, Level, Timings and any Comments.

To further assess whether or to what extent the learner's fluency has improved, an additional step may be provided where a previously unsighted passage corresponding to the Reader's Reading Age is presented to the reader and the reader's colours ability to read the passage is assessed.

In another embodiment, multiple groups of texts made be provided to the learner. Each group of texts displaying a different story and including a predetermined number of text levels and Stages.

If the language becomes too difficult for the learner in one of Stages: Early Stage 2, Stage 2 or Stage 3, the reader may begin another story at Stage 1. The fluency of the learner is assessed at the highest stage and text level the learner achieves and the above described timings are recorded before moving on to another story. Alternatively, another story may be begun at any time.

The story may also be selected based on choice of content and to enable readers to read another story if fluency hasn't been achieved at the end of their chosen first story. Each story has descriptive language, phrases and clauses. In one embodiment, the sentences are designed to be lengthy to provide more of a challenge in terms of reading fluently.

Referring to FIG. 1, in the fifth step 90 a decision may be made as to whether Steps 1 to Step 4 need to be repeated with a different story.

In Early Stage 2, Stage 2 or Stage 3, once the learner has read the respective first text level 15, 92, 192 or 292 the better reader may read the respective second text level 25, 94, 194 or 294 once or even by-pass it altogether and move onto the respective third text level 45, 96, 196 or 296 or the respective fourth text level 70, 98, 198 or 298.

In one embodiment, if a word is not known by the learner the pronunciation of the word is audibly communicated to the learner then the learner is prompted to audibly repeat the word. The learner is then encouraged to practice the word until they feel confident. In fact, a further step may be introduced of presenting the learner with a list of words corresponding to the relevant stage in syllable form. An example of such a list is shown in FIG. 19. Preferably, this step is executed immediately before Steps 2, 3 and 4. This by-passes the need for phonological understanding and application.

In the depicted embodiment, at least one of the words in each word group of the second, third and fourth levels of each stage are displayed in a different colour (orange) to another word in the or each respective word group (black). Generally speaking, the colours of adjacent words in the word groups alternate although this is not true in all instances. For example, in exemplary word group 400 in the fourth level text 70 of Stage 1 which states, “Billwasahelperataschool”, the words “was”, “helper” and “a” are all presented in the colour orange and in bold and italic format. Generally speaking, the colours are used to separate words within phrases.

In one variation all texts can be available to be displayed in two different colour modes. In a first mode the abovementioned words are displayed in a first colour (e.g. orange) while in a second mode the abovementioned words are displayed in a second colour (e.g. blue). In this case, a further step may be provided of allowing the learner to select their preferred colour and thereafter the texts are made available to the leaner in their preferred colour mode. It has been found that normally one colour works better for a reader than another (i.e. one colour better suits the reader's visual perception). More colour modes may be made available to the learner to form a group of colour modes. A further step may be provided of allowing a learner to select a different colour mode from the group of colour modes.

A border is provided around the second, third and fourth level texts of each Stage which is the same colour as the colour of the respective colour mode. The border enhances or highlights the colour in the respective text.

In one embodiment, each word group of each text level of each stage is spaced from adjacent word groups by more than one stroke of a computer space bar. For example, the word group 400 is spaced from the adjacent word group 405 which states, “He liked birds” by at least three spaces. These extended spaces are provided to encourage the reader to pause between the spaces.

In one embodiment, only one text level (e.g. the fourth text level 70 of Stage 1) is displayed to the learner at a time. This helps avoid information overload and thus daunting the learner.

It should be appreciated that in one embodiment of the invention, the flowchart shown in FIG. 1 merely illustrates a subset of the total steps provided by the invention.

In another form of the invention, an educational aid is provided comprising a book displaying any or all of the abovementioned texts. The book may comprise a multiplicity of pages and each text level (e.g. the fourth text level 70 of Stage 1) is displayed on a separate page. Thus, in the case of the depicted embodiment, each of FIGS. 2 to 17 is displayed on a separate page. Additional pages may be provided that have a similar structure as previous pages but tell a different story. For example, the book may comprise five different stories. Furthermore, additional pages may be provided where the abovementioned texts are in a second colour mode. For example, the or each story may be provided in three different colour modes (e.g. green, blue and red) from which the learner may select which colour mode they would like to use.

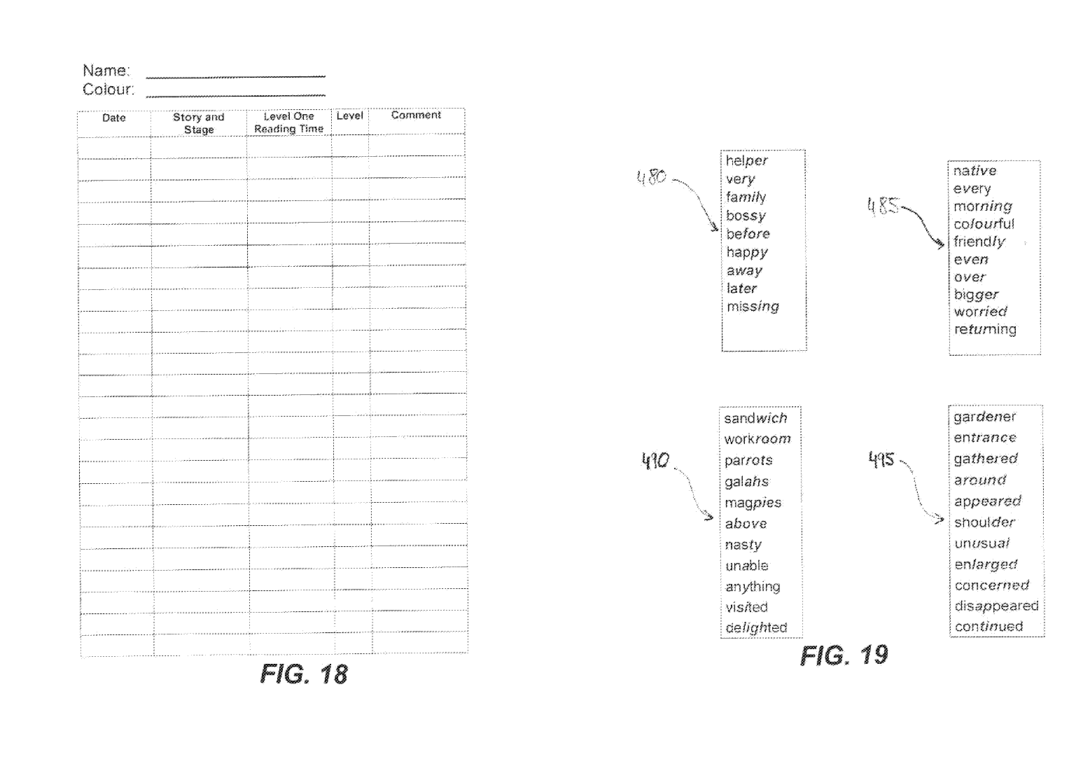

FIG. 18 shows an optional further record page of the educational aid which comprises a “Record Sheet” in which the time taken for the learner to read the first level text 15, 92, 192, 292 of the respective Stage may be recorded. That is, the record page may be used to assist the carrying out of the timing steps 311-314. Advantageously, the Record Sheet will evidence any improvement in the learner's fluency. In one embodiment, the Record Sheet may also be adapted for the recording the Learner'colours Name, the Date, Story, Stage, Level, Timings and any Comments.

FIG. 19 depicts a number of vocabulary lists 480, 485, 490, 495 corresponding to Stage 1, Early Stage 2, Stage 2 and Stage 3, respectively. The lists 480-495 may be learnt by the learner in an additional step before commencement of reading of the respective Stage texts. The vocabulary lists may also form an optional further page of the education aid. In one embodiment, the vocabulary lists are provided in different colours corresponding to the colour modes of the texts and the learner chooses their preferred colour mode before commencing practice of the vocabulary lists of their preferred colour mode.

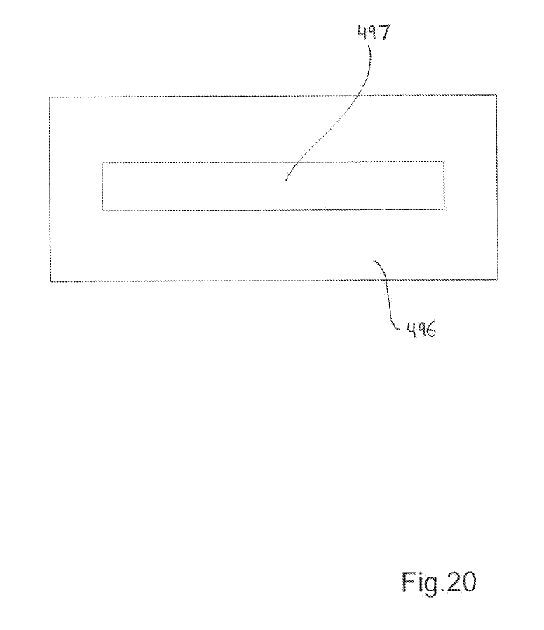

FIG. 20 depicts a tracking aid component of the educational aid and comprises a thin plate 496 having a rectangular window 497 therein such that in use a user can move the tracking aid down a text as they read it and only view one complete line of the text at a time. The window 497 also helps the reader focus on the writing to be read. The tracking aid helps learner's who are having difficulty with tracking the texts.

In one variation, one side of the thin plate 496 is coloured in a first and the other side of the thin plate is coloured in a second colour such that a learner may select which colour faces towards them in use. The colour may or may not correspond with the colours associated with one of the above described colour modes.

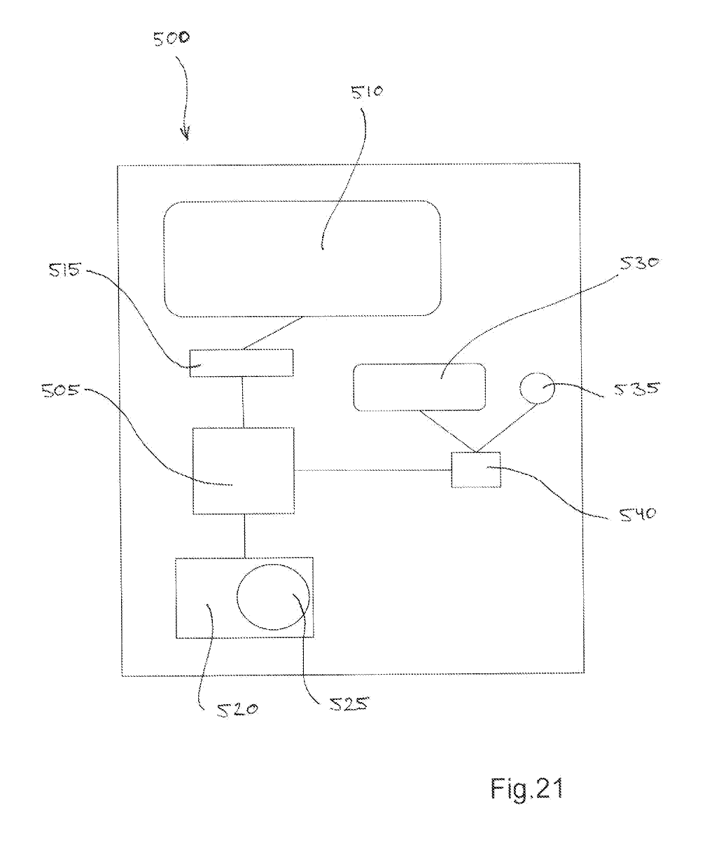

FIG. 21 depicts a computer 500 comprising a processor 505, a display 510 operatively connected to the processor 505 via a video card 515, and a memory device 520 operatively connected to the processor 505 and containing a computer program 525 for execution by the processor 505. The computer program 525 comprises a number of computer executable process steps that are adapted to execute any or all of the abovementioned steps (e.g. Steps 1 to 7) by controlling the computer 500. Controlling the computer 500 includes controlling the display 510 to display the relevant texts to the learner and accepting inputs from the learner by a keyboard 530 and mouse 535 via a communications port 540.

In one variation, the computer program 525 is recorded on a data storage means other than the memory device 520. For example, the computer program 525 is recorded on a portable USB drive/stick or on a floppy disk.

In another embodiment, a data storage means is also provided and comprises the above computer program 525 and is adapted for operative connection to the computer 500 for execution of the computer program 525.

One version of the oral reading program provides regular reading, up to five times a week, if used in a school situation, more if used in the home; progressive modeling of fluency in reading, thus giving the reader the opportunity to learn the pattern of fluency in reading; three developing levels of fluency, the last level being the most fluent level, allowing the learner to read with expression; and it decreases the time spent reading a text so comprehension is enhanced.

While the invention has been described with reference to a number of preferred embodiments it should be appreciated that the invention can be embodied in many other forms.

For example, small variations to the wording of text levels of a single Stage may be provided but where all of the text levels involve the same linguistic complexity. In another embodiment, more significant variations to the wording of the text levels of a single Stage are provided but where all text levels involve substantially the same linguistic complexity.

In one variation, further steps may be introduced between the fourth step 65 and the fifth step 90 of the above described embodiment. For example, a new fifth level text step may involve displaying a fifth level text to the learner. The fifth level text would comprise the same words as the first level text 15 (i.e. the same story). A number of words of the fifth level text would be concatenated to form a number of fifth level word groups. Furthermore, a subset of the fifth level word groups would comprise a greater number of concatenated words than any one of the fourth level word groups. However, not all of the fifth level word groups would comprise a greater number of concatenated words than the fourth level word groups. As the learner reads through the fifth level text, the omission of spaces between the concatenated words of the word groups prompts the learner to read the concatenated words in quick succession. This improves the learner's reading fluency since the learner is not pausing for too long between words they may have otherwise paused between.

In another variation, another level text step may be provided and so on. In yet another variation, up to ten such further text level steps may be provided.

In another variation, each of Steps 2 to 4 may be repeated multiple times before moving onto the next step.

Preferably, one reading session involves the learner reading about two pages of text.

It should be understood that an improvement in reading fluency may encompass an improvement in either reading speed or smoothness of speech or both.

In this specification, “in quick succession” means that the learner does not pause between the relevant words. Conversely, the reader is encouraged to pause between the spaced word groups. The reader is encouraged to read in phrases.

It should also be appreciated that embodiments of the invention aid a learner in terms of both cognitive reading and oral reading (i.e. reading out-loud) fluency.

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

1. A method of educating a learner, comprising the following steps:
displaying a first level text to the learner, and
displaying a second level text to the learner comprising the same words as the first level text and wherein two or more words are concatenated to form at least one second level word group to prompt the learner to read the concatenated words in quick succession improving the learner's reading fluency.

2. A method as defined in claim 1, further comprising the following step:
displaying a third level text to the learner after the step of displaying a second level text to the learner, the third level text comprising the same words as the first level text and wherein two or more words are concatenated to form at least one third level word group, the or at least one of which comprises a greater number of concatenated words than the or each at least one second level word group to prompt the learner to read the concatenated words in quick succession further improving the learner's reading fluency.

3. A method as defined in claim 2, further comprising the following step:
displaying a fourth level text to the learner after the step of displaying a third level text to the learner, the fourth level text comprising the same words as the first level text and wherein two or more words are concatenated to form at least one fourth level word group, the or at least one of which comprises a greater number of concatenated words than the or each at least one third level word group to prompt the learner to read the concatenated words in quick succession further improving the learner's reading fluency.

4. A method as defined in claim 3, further comprising the following step:
displaying a fifth level text to the learner after the step of displaying a fourth level text to the learner, the fifth level text comprising the same words as the first level text and wherein two or more words are concatenated to form at least one fifth level word group, the or at least one of which comprises a greater number of concatenated words than the or each at least one fourth level word group to
prompt the learner to read the concatenated words in quick succession further improving the learner's reading fluency.

5. A method as defined in claim 1, further comprising the following step:
repeating the previous steps wherein the respective texts are mildly more linguistically complex but relate to substantially corresponding subject matter.

6. A method as defined in claim 5, further comprising the following step:
repeating the step of claim 1, wherein the respective texts are moderately more linguistically complex but relate to substantially corresponding subject matter.

7. A method as defined in claim 6, further comprising the following step:
repeating the step of claim 1, wherein the respective texts are significantly more linguistically complex but relate to substantially corresponding subject matter.

8. A method as defined in claim 1, further comprising the following steps:
timing the time taken by the learner to read the first level text before the step of displaying the second level text and recording the time taken as an initial time.
timing the time taken by the learner to read the first level text after the step of displaying the highest level text to the learner and the learner having read the highest level text at least once and recording the time taken as a final time.

9. A method as defined in claim 8, wherein the highest level text is read by the learner twice before the final time is recorded.

10. A method as defined in claim 8, further comprising the following step:
comparing the final time to the initial time to observe whether the learner is reading more fluently.

11. A method as defined in claim 1, further comprising the following steps if a word is not known by the learner:
communicating the pronunciation of the word audibly, then
prompting the learner to repeat the word.

12. A method as defined in claim 1, wherein at least one of the words in the or each word group is displayed in a different color to another word in the or each respective word group.

13. A method as defined in claim 12, wherein colors of adjacent words in the or each respective word group alternate.

14. A method as defined in claim 13, wherein colors of adjacent words in the second level text and in higher level texts, if applicable, alternate.

15. A method as defined in claim 14, further comprising the step of allowing a learner to select the color of the at least one of the words from a color group of at least two colors according to personal preference.

16. A method as defined in claim 15, wherein the color group comprises the colors orange and blue.

17. A method as defined in claim 15, further comprising the step of allowing a learner to select a different color from the color group.

18. A method as defined in claim 12, wherein the at least one of the words displayed in a different color is also displayed in bold and italicized.

19. A method as defined in claim 1, wherein the or each word group is spaced from adjacent words by more than one stroke of a computer space bar.

20. A method as defined in claim 1, wherein only one text is displayed to the learner at a time.

21. A method as defined in claim 1, wherein the texts form a story.

22. A method as defined in claim 21, further comprising the following step:
repeating the preceding steps wherein the texts form a different story.

23. (canceled)

24. An educational aid comprising a book displaying the texts, wherein the book comprises a multiplicity of pages and each text is displayed on a separate page.

25. An educational aid as defined in claim 24, wherein at least one of the pages comprises a recording portion in which the initial time and final time may be recorded.

26. An educational aid as defined in claim 24, further comprising a tracking aid comprising a thin plate having a rectangular window therein such that in use a user can move the tracking aid down a text as they read it and only view between one and three complete lines of the text at a time.

27. An educational aid as defined in claim 26, wherein one side of the thin plate is colored in a first color and the other side of the thin plate is colored in a second color such that a learner may select which color faces towards them in use.

28-29. (canceled)

30. A computer program adapted to execute the steps of claim 1 on a computer; comprising:
a processor,
a display operatively connected to the processor,
a memory device operatively connected to the processor and containing a computer program for execution by the processor, and wherein the display is adapted to display the respective texts to the learner.

31. The computer program of claim 30 recorded on a data storage means.

32. A data storage means comprising the computer program of claim 30 and being adapted for operative connection to a computer for execution of the computer program.

33-34. (canceled)
